(19) United States
(12) Patent Application Publication
(10) Pub. No.: US 2021/0354082 A1
(43) Pub. Date: Nov. 18, 2021

(54) DEVICE FOR RECOVERING POLLUTED AIR

(71) Applicant: Teshima Tusho Corporation, Kochi (JP)

(72) Inventor: Hiromitsu Teshima, Kochi (JP)

(21) Appl. No.: 17/256,173

(22) PCT Filed: Jun. 28, 2019
(86) PCT No.: PCT/JP2019/025855

§ 371 Date: Jul. 26, 2021

(30) Foreign Application Priority Data
Jun. 28, 2018 (JP) 2018-123682

(51) Int. Cl. B01D 53/34; B01D 53/75; B01D 53/76; B01D 53/73

(52) U.S. Cl. CPC B01D 53/346; B01D 53/75; B01D 53/60; B01D 53/73; B01D 53/76

(57) ABSTRACT

A device for recovering polluted air is disclosed. The device includes air collecting part, a main control part, a discharging part, and an air sending pipe. The air collecting part includes a cover body, a lower side of which is opened, and a filter member attached to an inside of the cover body. The main control part includes a pump capable of sucking and delivering gas. The discharging part including an air storage container to be installed in the sea. The air sending pipe couples between the air collecting part and the main control part and between the main control part and the discharging part to permit movement of the gas between the parts. The gas that is polluted air is sucked from the air collecting part by the pump and is delivered to the discharging part, and the gas is discharged from the air storage container into the sea.

### CROSS-REFERENCE TO RELATED APPLICATIONS

This application claims priority to International Patent Application No. PCT/JP2019/025855 filed Jun. 28, 2019, which claims priority to Japan Patent Application JP 2018-123682 filed Jun. 28, 2018, the contents of each of which is hereby incorporated by reference in its entirety.

### TECHNICAL FIELD

The present invention relates to a device for recovering polluted air that recovers a gas that is polluted air and then discharges the gas from an air storage container installed in the sea.

### BACKGROUND

In recent years, damages caused by air pollution have become more serious both within Japan and overseas, and automobile exhaust gas, brake marks, tire shavings, exhaust gas from industrial facilities such as factories and plants, or environmentally-derived dust can be considered to be causes of the air pollution. Its effects cannot be avoided not only in urban areas but also in rural areas, and there is a risk of causing health hazards due to air pollutants including harmful substance particles in the atmosphere.

The air pollution caused by air pollutants, in combination with excessive evaporation of water vapor on the sea, promotes the frequent occurrence and intensification of water vapor saturation, and leads to a vicious cycle of meteorological disasters such as local warming and torrential rain.

In order to deal with this, for example, JP H07-185266 A (Patent Literature 1) discloses an invention relating to a gas purification unit by catalysis to be installed in a constructed thing such as a street lamp. In addition, for example, JP 2002-309530 A (Patent Literature 2) and JP 2010-131559 A (Patent Literature 3) disclose inventions relating to purification devices, to be installed on the road or the like, for condensing and removing harmful substance particles in the polluted air into droplets of water by spraying water.

These inventions are for purifying on the spot the air pollutants generated from the exhaust gas of automobiles traveling on the road, which is one of the main causes of the air pollution. However, each device has to include a purification means as many as the installed number of the devices. Hence, there is an issue that the installation cost and the maintenance cost increase accordingly, as the installation range expands, and there is a demand for a product that can prevent the air pollution in a wide range relatively easily.

### PATENT LITERATURE

Patent Literature 1: JP H07-185266 A

Patent Literature 2: JP 2002-309530 A

Patent Literature 3: JP 2010-131559 A

Patent Literature 4: JP 2015-86675 A

### SUMMARY

The present invention has an object to provide a device for recovering polluted air to be capable of easily recovering and detoxifying the polluted air over a wide range.

In order to address the above issue, a device for recovering polluted air according to the present invention includes: an air collecting part; a main control part; a discharging part; and an air sending pipe, in which the air collecting part includes a cover body, a lower side of which is opened, and a filter member attached to an inside of the cover body, the main control part includes a pump capable of sucking and delivering gas, the discharging part includes an air storage container to be installed in the sea, the air sending pipe couples between the air collecting part and the main control part and between the main control part and the discharging part to enable movement of the gas between the parts, and the gas that is polluted air is sucked from the air collecting part by the pump and is delivered to the discharging part, and the gas is discharged from the air storage container into the sea.

Further, the air storage container has a hollow cylindrical shape with both ends closed, and includes a plurality of ejection ports each including a pressure adjustment cap, and after an inside of the air storage container is filled with the gas, by discharging a given amount of the gas from the ejection port through the pressure adjustment cap, while the inside of the air storage container is kept at a predetermined pressure, the gas is dischargeable.

Further, the pressure adjustment cap includes: a cap body which has a bottomed hollow shape in which an opening top part is connected to surround the ejection port, and in which a through hole is formed in a peripheral wall; a valve seat arranged in the cap body; and a float valve arranged in the cap body, seated on the valve seat by buoyancy, and capable of closing the ejection port, in a case where the inside of the air storage container exceeds the predetermined pressure due to the gas that has been delivered, the float valve is separated from the valve seat, the given amount of the gas is discharged from the ejection port that is opened through the through hole of the cap body, and the inside of the air storage container is kept at the predetermined pressure at normal times.

Further, the air storage container has a semi-cylindrical shape with a lower surface opening and both ends closed, and after the inside of the air storage container is filled with the gas, by discharging the gas that is excessive from a peripheral edge of the opening, while the gas in the air storage container is kept at a given amount, the gas is dischargeable.

Further, the air storage container has a hollow cylindrical shape with both ends closed, and includes a plurality of ejection ports each including a check valve, and an inside of the air storage container includes an air supply pipe that communicates with the air sending pipe, after the inside of the air storage container is filled with the gas supplied through the air supply pipe, by discharging a given amount of the gas from the ejection port, while the inside of the air storage container is kept at a predetermined pressure, the gas is dischargeable.

Further, the air storage container has a semi-cylindrical shape with a lower surface opening and both ends closed, a wire connected with a float is attached to a peripheral wall of the air storage container, and the float reacts with a wave and pulls the wire, the air storage container rotates, and the gas stored in the air storage container is dischargeable.

Further, a discharge hole is formed to penetrate through a lower surface of the air sending pipe and a trap that covers the discharge hole is provided, on a route of the air sending pipe, the trap includes a trap member that covers the discharge hole formed on the air sending pipe, a drain hole that is formed to penetrate through the lower surface of the trap member, and a drain screw to be screwed into the drain hole, and water or minute foreign matters contained in the gas passing through the air sending pipe are dropped into the trap member and are dischargeable from the drain hole.

According to the present invention, by recovering polluted air such as exhaust gas discharged from automobiles and industrial plants, on the spot where the polluted air is generated, air pollution is reduced in the corresponding area, and the polluted air that has been recovered is transported and a certain amount is discharged from the air storage container installed in the sea. Thus, the air pollution can be prevented by the synergistic effect of detoxifying the polluted air with seawater and microorganisms in the sea.

Furthermore, in a case where the air storage container includes a simultaneous discharging means, the gas inside the air storage container is simultaneously discharged to generate bubbles when a tsunami or an emergency occurs. This mitigates the mass transport energy of the tsunami passing above the air storage container, mitigates the damage, and prevents the invasion of ships.

### BRIEF DESCRIPTION OF THE DRAWINGS

FIG. 1 is an explanatory view showing a preferred embodiment of the present invention.

FIG. 2 is a vertical sectional view of an air collecting part according to the embodiment shown in FIG. 1.

FIG. 3 is a bottom view of the air collecting part according to the embodiment shown in FIG. 1.

FIG. 4 is a schematic view showing an installation state of the air collecting part according to the embodiment shown in FIG. 1.

FIG. 5 is a vertical sectional view of the air collecting part having a different shape.

FIG. 6 is a plan view of the air collecting part shown in FIG. 5.

FIG. 7A is a cross-sectional view and FIG. 7B is a cross-sectional view at a different angle of a trap according to the embodiment shown in FIG. 1.

FIG. 8A is a schematic view, FIG. 8B is an enlarged cross-sectional view, and FIG. 8C is a further enlarged partial cross-sectional view of a discharging part according to the embodiment shown in FIG. 1.

FIG. 9 is an explanatory view showing another discharging part of the present invention.

FIG. 10 is an explanatory view showing another discharging part of the present invention.

FIG. 11 is an explanatory view showing another discharging part of the present invention.

FIG. 12 is a cross-sectional view showing the discharging part shown in FIG. 11.

FIG. 13 is a side view showing the discharging part shown in FIG. 11.

FIG. 14 is an explanatory view showing another discharging part of the present invention.

FIG. 15 is an explanatory view showing another embodiment of the present invention.

### DETAILED DESCRIPTION

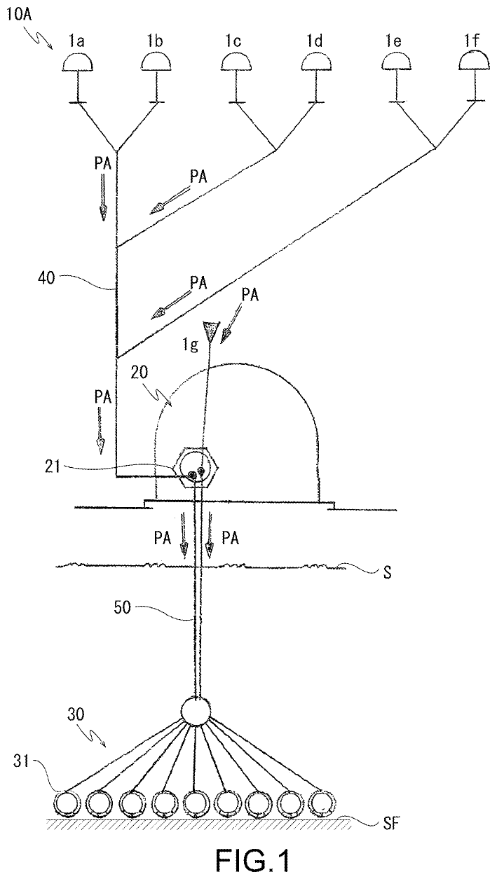

FIG. 1 is an explanatory view showing a preferred embodiment of the present invention. A device for recovering polluted air according to the present invention includes an air collecting part 10A, a main control part 20, a discharging part 30, a suction-side air sending pipe 40 for coupling between the air collecting part 10A and the main control part 20, and a delivery-side air sending pipe 50 for coupling between the main control part 20 and the discharging part 30.

In FIG. 1, reference numerals 1a to if each denote an area where the air collecting part 10A is installed. There are a residential area 1a with heavy traffic, a highway area 1b, a traffic congestion frequently occurring area 1c, an industrial plant area 1d, an urban air pollution time zone 1e, and an area with a lot of dust scattering harmful substance particles 1f. Further, reference numeral 1g indicates a polluted air route directly introduced into the main control part 20 without passing through the suction-side air sending pipe 40, reference numeral S indicates the sea surface, and reference numeral SF indicates the sea floor.

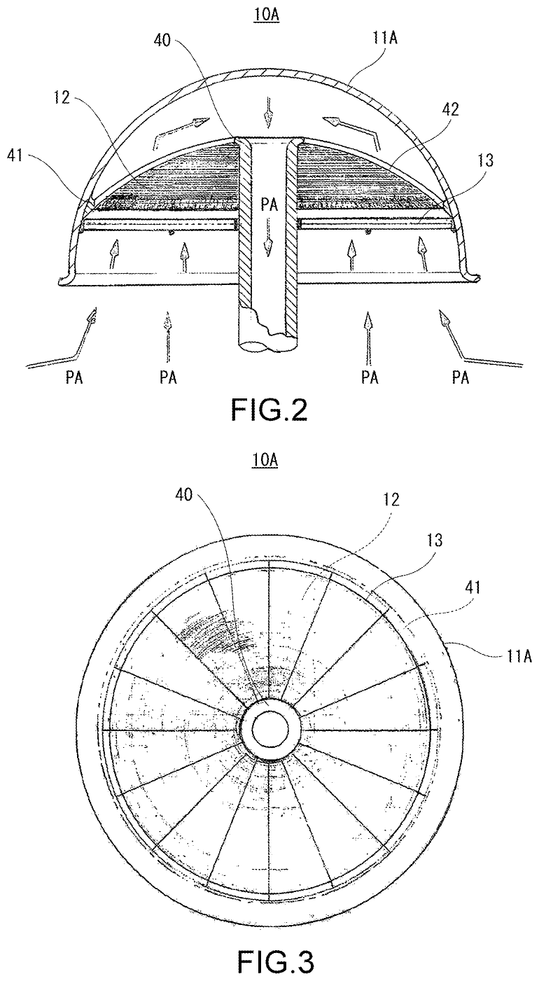

FIG. 2 is a vertical sectional view of the air collecting part 10A, and FIG. 3 is a bottom view of the air collecting part 10A. The air collecting part 10A includes a cover body 11A, which has a bowl shape and which is opened downward, a filter member 12 attached to the inside of the cover body 11A, and a mesh member 13 stretched below the filter member 12. The air collecting part 10A is installed in a polluted air atmosphere where polluted air PA containing air pollutants is existent, for example, on the streets where automobiles pass or in the vicinity of industrial facilities such as factories and plants.

In the inside the cover body 11A, the suction-side air sending pipe 40, which is opened upward, and the opening of which substantially coincides with the center line of the cover body 11A, is integrally supported by a flange 41 extending downward in an umbrella-like shape from the peripheral edge of the opening. In addition, a vent 42 is formed in the flange 41. By driving a pump 21 of the main control part 20, the suction-side air sending pipe 40 is brought into negative pressure, the surrounding polluted air PA is gently sucked into the suction-side air sending pipe 40 from the opening of the cover body 11A, sequentially passes through the mesh member 13, the filter member 12, and the vent 42 of the flange 41, and the polluted air PA that has been sucked is transported to the main control part 20 connected on a subsequent stage.

As the filter member 12, for example, a conventionally known filter for air purification formed of a non-woven fabric, glass fiber, or the like can be used to remove moisture, minute foreign matters, and the like in the polluted air PA that has been sucked. It is desirable in particular that the filter member 12 is installed to be exchangeable.

As the mesh member 13, for example, a conventionally known mesh formed of metal or synthetic fiber can be used to remove relatively large foreign matters, insects, and the like in the polluted air PA. It is desirable in particular that the mesh member 13 is installed to be exchangeable.

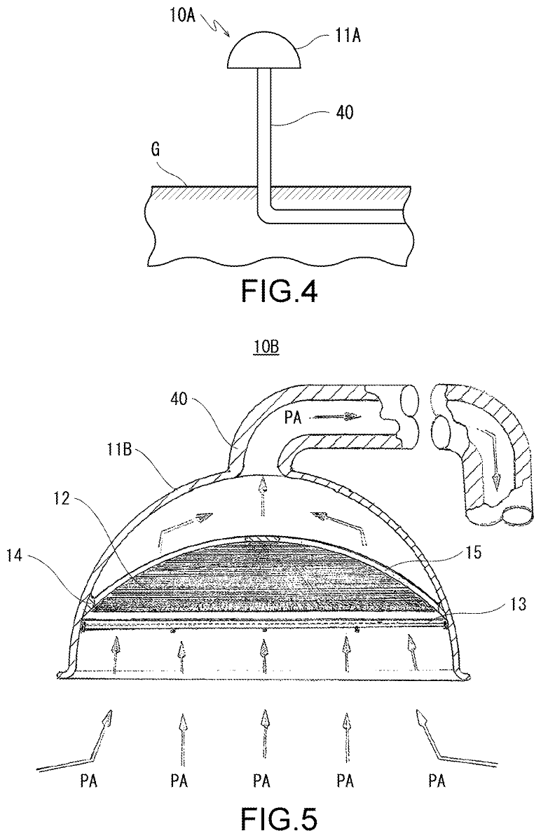

FIG. 4 is a schematic view showing the air collecting part 10A and the suction-side air sending pipe 40. The suction-side air sending pipe 40 is divided into an above-ground part and an underground part. The above-ground part stands at a predetermined height from the ground G. For example, by setting the height close to a guardrail or pole (about 1 m), the purpose of sucking the polluted air is achieved while reducing the possibility of obstructing the view of passers-by and drivers or obstructing the landscape scenery as much as possible. However, in a case where a large amount of exhaust gas is emitted on a road with heavy traffic, for example, the height close to a street light (about 3 m) may be set so that a wider range of the polluted air can be sucked.

The suction-side air sending pipe 40 in the underground part passes through the ground as it is and is coupled with the main control part 20. This is desirable in particular, because the labor of construction can be reduced by using existing piping equipment, for example, a sewerage pipe or the like.

For the suction-side air sending pipe 40 in the present embodiment, a metal pipe having an inner surface and an outer surface that are coated and having self-supporting strength is used. However, for example, a support column and the suction-side air sending pipe are configured with separate members (not shown). In addition, in a place where enough space is available, such as an industrial facility in a suburb, the suction-side air sending pipe may be disposed on the ground without being embedded in the ground (not shown).

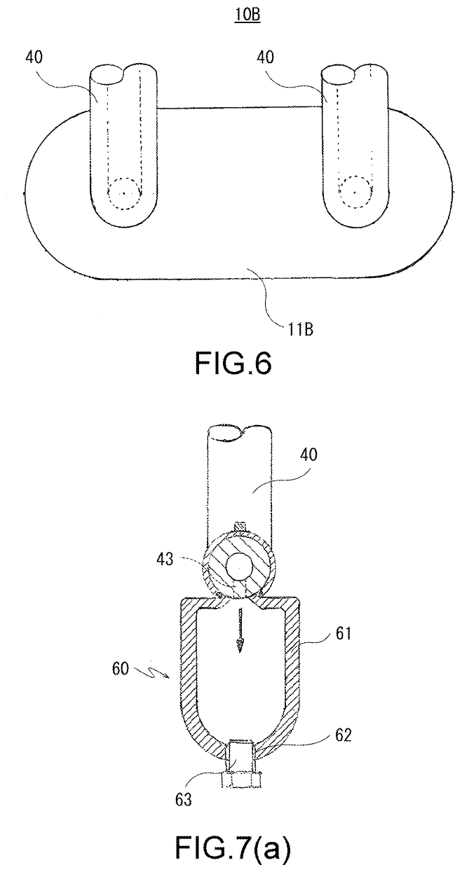

FIG. 5 is a vertical sectional view of an air collecting part 10B having a different shape, and FIG. 6 is a plan view of the air collecting part 10B. This air collecting part is different from the air collecting part 10A shown in FIGS. 1 to 4 in that a cover body 11B has a rectangular shape with rounded corners in plan view and there are two suction-side air sending pipes 40 connected with the cover body 11B.

Further, the suction-side air sending pipes 40 in the air collecting part 10B are opened downward and are integrated with the cover body 11B. Hence, the polluted air PA that has been sucked from the opening of the cover body 11B sequentially passes through the mesh member 13, the filter member 12, and a vent 15 of a support body 14, and is smoothly guided to the suction-side air sending pipe 40 without reversing the direction of the flow. The support body 14, in which a plurality of vents 15 are formed, has a rectangular shape with rounded corners in plan view and an arc shape in longitudinal sectional view, and is used for attaching the filter member 12.

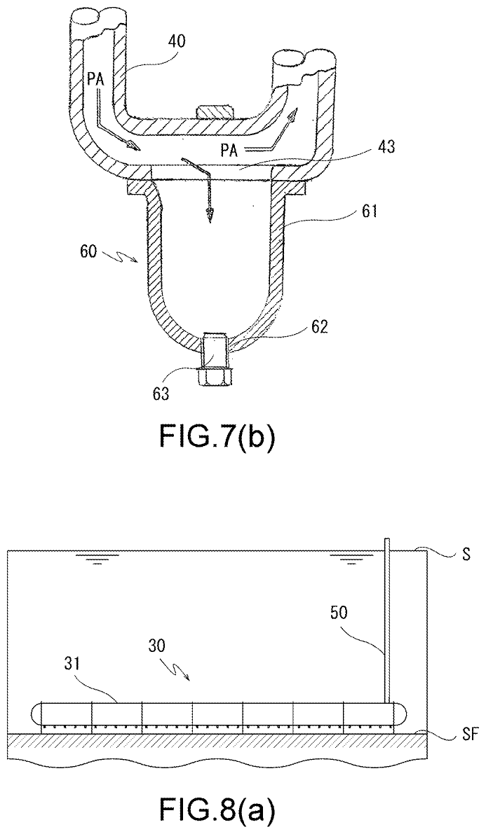

FIG. 7 is a diagram showing a trap 60 attached on the route of the suction-side air sending pipe 40. As shown in this drawing, a discharge hole 43 is formed to penetrate through the lower surface of the suction-side air sending pipe 40, which is partially bent to protrude downward, and a trap member 61 is externally attached to cover the discharge hole 43.

The trap 60 is for dropping and recovering moisture and minute foreign matters contained in the polluted air PA, which is transported through the suction-side air sending pipe 40, in the trap member 61. By removing a drain screw 63 screwed into a drain hole 62, which is formed to penetrate through the lower surface of the trap member 61, water, minute foreign matters, and the like that have been accumulated can be discharged from the drain hole 62.

The main control part 20 includes the pump 21 capable of sucking and delivering gas. As the pump 21, a conventionally known pump can be used, and the method is not limited.

Further, in a case where the main control part 20 is equipped with a purification facility capable of purifying the polluted air PA, for example, air pollutants derived from exhaust gas such as sulfur oxides and nitrogen oxides contained in the polluted air PA are purified to some extent, and then can be transported to the discharging part 30. This is more desirable for the marine environment (not shown).

Then, the polluted air PA that has passed through the pump 21 of the main control part 20 is transported through the delivery-side air sending pipe 50, and is supplied to the discharging part 30.

An impeller for sucking the gas from the air collecting part 10 toward the discharging part 30 is installed in the suction-side air sending pipe 40 or the delivery-side air sending pipe 50. For example, the impeller may be rotated by a motor driven by electric power to assist the pump 21 (not shown).

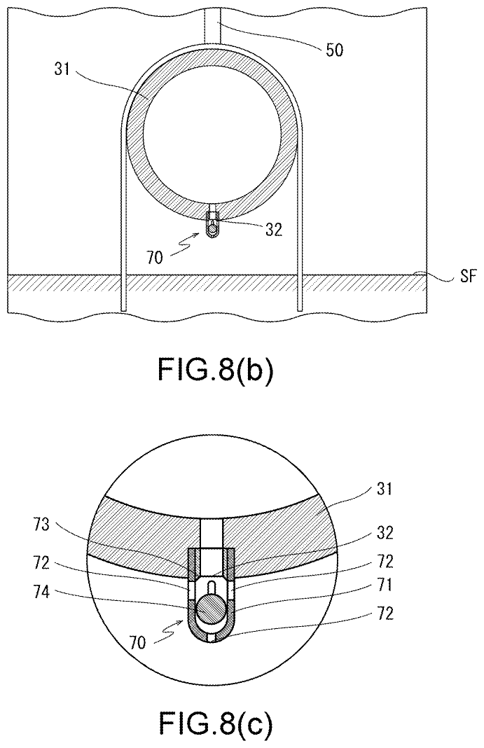

FIG. 8 is a diagram showing the discharging part 30. The discharging part 30 includes an air storage pipe 31, which is an air storage container to be installed in the sea, which has a hollow cylindrical shape, and both ends of which are closed, and a plurality of ejection ports 32 arranged on the lower surface of the air storage pipe 31. Each ejection port 32 is provided with a pressure adjustment cap 70 including: a cap body 71, in which an opening top that couples so as to surround the ejection port 32, which has a bottomed hollow shape, and in which a through hole 72 is formed in a peripheral wall; a valve seat 73 arranged inside the cap body 71; and a float valve 74, which is provided in the cap body 71, and which is capable of closing the ejection port 32 by sitting on the valve seat 73 by buoyancy.

Then, when the inside of the air storage pipe 31 exceeds a predetermined pressure due to the polluted air PA supplied through the delivery-side air sending pipe 50, the float valve 74 is separated from the valve seat 73. A certain amount of the polluted air PA is discharged from the ejection port 32, which is opened, through the through hole 72 of the cap body 71. At normal times, the inside of the air storage pipe 31 is kept at a predetermined pressure.

In this manner, the inside of the air storage pipe 31 is always kept at a predetermined pressure. When more polluted air PA is supplied, with respect to excessive polluted air PA that exceeds the predetermined pressure, by configuring such that the pressure adjustment cap 70 operates to discharge the polluted air PA into the sea, a certain amount of the polluted air PA can be discharged easily without the need of any control.

In the present embodiment, by using a float valve type of the pressure adjustment cap, while the balance between the pressure inside the air storage pipe 31 and the buoyancy applied to the float valve 74 keeps a predetermined pressure inside the air storage pipe 31, the excessive polluted air PA is discharged. However, on the contrary, the ejection port 32 may be formed above the air storage pipe 31, and the pressure adjustment cap may be configured with a check valve such as a lift valve, for example (not shown).

Further, in a case where the air storage pipe 31 is provided with a simultaneous discharging means, the simultaneous discharging means reacts at an occurrence of a tsunami or the like, and simultaneously ejects the polluted air PA stored in the air storage pipe 31. Hence, with the upper sea area of the air storage pipe 31 as a bubble-filled sea area, the waves with high mass transport energy that are rushing to the bubble-filled sea area one after another compress the bubbles and absorb the energy. Therefore, the energy of the waves is mitigated before reaching the coastal area, which contributes to disaster prevention.

For details on the mechanism for mitigating the wave energy using bubbles, see a Patent Publication filed by the applicant of the present application (JP 2015-86675 A, Patent Literature 4).

As a specific simultaneous discharging means in the present embodiment, by rapidly increasing the flow rate of the polluted air PA delivered from the pump 21, the discharged amount of the polluted air PA from the air storage pipe 31 can be increased and discharged simultaneously.

As another simultaneous discharging means, the air storage pipe 31 is attached to be axially rotatable. By axially rotating the air storage pipe 31 by 180 degrees, the ejection port 32 faces the sea surface and the float valve 74 is always separated from the valve seat 73. Accordingly, the polluted air PA inside the air storage pipe 31 can be discharged simultaneously (not shown).

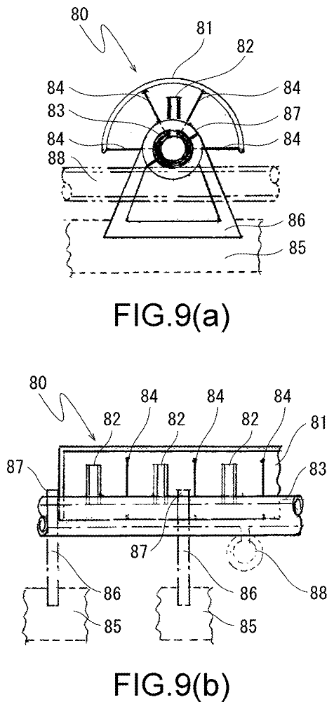

FIG. 9 is a diagram showing another discharging part 80 according to the present invention. The discharging part 80 includes: an air storage container 81, which is installed in the sea, which has a semi-cylindrical shape with a lower surface opening, and both ends of which are closed; an air supply pipe 83 in which a plurality of ejection ports 82 for supplying air to the inside of the air storage container 81 are formed on an upper surface; a beam 84 for coupling the air storage container 81 and the air supply pipe 83; a weight 85 for fixing the discharging part 80 on the sea floor SF; a leg part 86, which stands up from the weight 85; and a fixing part 87, which is dividable and which has an annular shape, for fixing the leg part 86 and the air supply pipe 83.

The delivery-side air sending pipe 50 and the air supply pipe 83 communicate with each other, and the polluted air PA delivered from above the ground passes through the delivery-side air sending pipe 50, the air supply pipe 83, and the ejection port 82, and is supplied to the air storage container 81.

Then, when the amount of the polluted air PA supplied to the air storage container 81 through the delivery-side air sending pipe 50, the air supply pipe 83, and the ejection port 82 exceeds a predetermined amount, the polluted air PA is discharged into the sea from the peripheral edge of the lower surface opening.

In this manner, the amount of the polluted air PA stored in the air storage container 81 is always kept at a certain amount. When more polluted air PA is supplied, by configuring such that excessive polluted air PA that exceeds the predetermined amount is automatically discharged into the sea, a certain amount of the polluted air PA can be discharged easily without the need of any control.

In a case where a plurality of rows of the discharging parts 80 that are arranged side by side are used, an air distribution pipe 88, which communicates with each air supply pipe 83, is used. The air distribution pipe 88 communicates with the delivery-side air sending pipe 50, and the polluted air PA to be delivered from above the ground can be easily distributed to each air supply pipe 83 via the air distribution pipe 88.

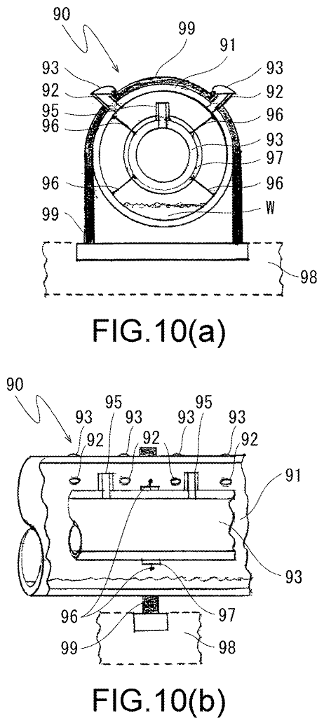

FIG. 10 is a diagram showing further another discharging part 90 according to the present invention. The discharging part 90 includes: an air storage pipe 91, which is an air storage container to be installed in the sea, which has a hollow cylindrical shape, and both ends of which are closed; a plurality of second ejection ports 92, which are formed in pairs at equal angles with respect to the axis of the air storage pipe 91 on an upper surface of the air storage pipe 91; a check valve 93, which is provided on an outer end face of the second ejection port 92, and which prevents backflow of seawater into the air storage pipe 91; an air supply pipe 94, which is provided inside the air storage pipe 91 to be coaxial with the axis of the air storage pipe 91, which has a long-sized hollow cylindrical shape, and both ends of which are closed; a plurality of first ejection ports 95, which are formed in a row on an upper surface of the air supply pipe 94; a beam 96 for coupling the air storage pipe 91 and the air supply pipe 94; a fixing part 97, which has a belt-like shape, and which is for fixing the beam 96 and the air supply pipe 94; a weight 98 for fixing the discharging part 90 to the sea floor SF; and a leg part 99, which stands up from the weight 98, and which is for fixing the weight 98 and the air storage pipe 91.

The delivery-side air sending pipe 50 and the air supply pipe 94 communicate with each other, and the polluted air PA delivered from above the ground passes through the delivery-side air sending pipe 50, and is supplied to the air storage pipe 91 via the first ejection port 95 of the air supply pipe 94.

Then, in a case where the inside of the air storage pipe 91 exceeds a predetermined pressure due to the polluted air PA supplied through the first ejection port 95 of the air supply pipe 94 to the air storage pipe 91 via the delivery-side air sending pipe 50, the check valve 93 provided in the second ejection port 92 is pushed up and opened, and the polluted air PA is discharged into the sea from the second ejection port 92.

In this manner, the inside of the air storage pipe 91 is always kept at a predetermined pressure. When more polluted air PA is supplied, with respect to excessive polluted air PA that exceeds the predetermined pressure, by configuring such that the check valve 93 operates to discharge the polluted air PA into the sea, a certain amount of the polluted air PA can be discharged easily without the need of any control.

In particular, the discharging part 90 has a double pipe structure including the air storage pipe 91 on the outside and the air supply pipe 94 on the inside. Therefore, when the check valve 93 is opened, even if seawater W enters the inside of the air storage pipe 91 from the second ejection port 92, the function is not affected.

Further, the air storage pipe 91 of the discharging part 90 and the air storage pipe 31 of the discharging part 30 shown in FIG. 1 are both cylindrical pipes with both ends closed. This brings an advantage that there is no risk of affecting the function due to the attachment of living organisms of the sea to the inside of the pipes.

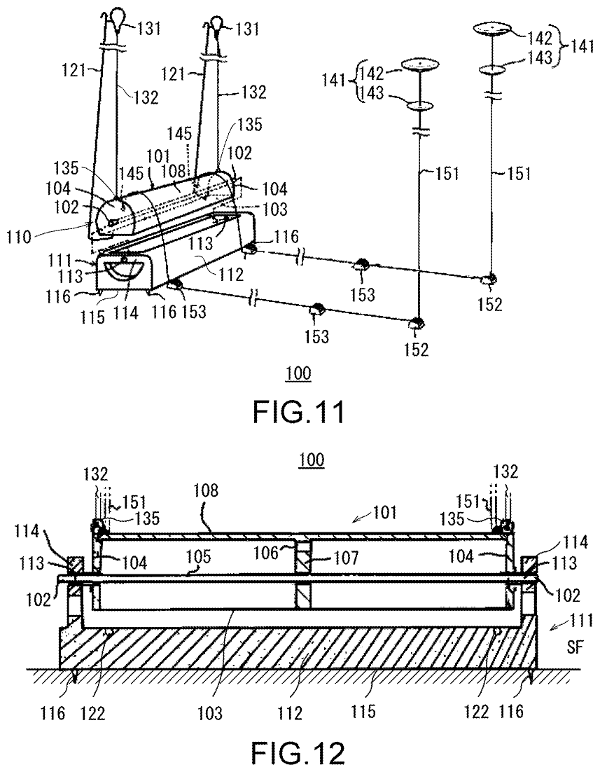

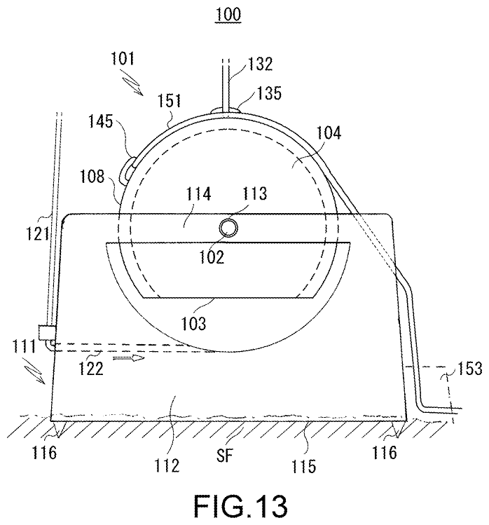

FIGS. 11 to 13 are views showing further another discharging part 100 of the present invention. The discharging part 100 includes: an air storage container 101, which is installed in the sea, which has a semi-cylindrical shape with a lower surface opening, and both ends of which are closed; a weight 111, which rotatably supports the air storage container 101 with rotation shafts 102, 102 provided to project from side walls of both ends along the central axis of the air storage container 101, and which holds the air storage container 101 near the sea floor SF; an air supply pipe 121 for supplying air to the inside of the air storage container 101; a rotation control float 131 for keeping an opening 103 of the air storage container 101 in an upright state facing the sea floor SF direction; a wave detection float 141, which is arranged near the sea surface S at a position horizontally separated from the air storage container 101 held near the sea floor SF by a predetermined distance; and an air storage container rotation wire 151 for coupling the wave detection float 141 and a peripheral wall 108 of the air storage container 101.

The opening 103 of the air storage container 101 is formed below the central axis of the air storage container 101. Depending on the opening area, shape, quantity, and the like of the opening 103, for example, depending on the water depth on which the air storage container 101 is arranged, the timing and amount of the stored gas to be ejected up can be adjusted, and the strength of the air storage container 101 is also adjustable.

The rotation shafts 102, 102 are configured with a central shaft 105, which is arranged along the central axis of the air storage container 101, and both ends of which are hermetically projected from side plates 104, 104 on both side surfaces of the air storage container 101 by a predetermined length. The central shaft 105 penetrates through the side plates 104, 104 on both side surfaces of the air storage container 101, and is arranged in the longitudinal direction in the air storage container 101. This brings an advantage of reinforcing the strength of the rotation shafts 102, 102 and the air storage container 101.

Further, in the air storage container 101, a reinforcing plate 107 is formed to have a substantially same shape as the side plate 104 having a through hole 106 at the center position in the longitudinal direction in order to prevent damage due to water pressure when installed in the sea. In addition, the polluted air PA to be stored can be distributed to the inside of the air storage container 101 through the through hole 106.

The air storage container 101 is arranged near the sea floor SF so that its central axis is horizontal.

The weight 111, which horizontally supports the air storage container 101 with the opening 103 facing the sea floor SF, has a substantially box shape with a trapezoidal shape in side view and an upper surface that is opened. The weight 111 includes: a weight body 112 formed of, for example, concrete or the like, and installed on the sea floor SF; and support parts 114 respectively formed at both ends of the weight body 112, respectively having shaft holes 113, and rotatably supporting the air storage container 101 horizontally by being inserted by the rotation shaft 102 above the weight body 112. The weight body 112 necessitates a fixing force (withstand load) capable of holding the air storage container 101, in which at least the polluted air PA is stored, on the sea floor SF having a predetermined depth against the buoyancy.

In the weight 111 in the present embodiment, wedge piles 116 for fixing to the sea floor SF are arranged at the four corners of a bottom surface 115, so that the weight 111 can be more firmly installed on the sea floor SF. There is no worry of slipping even when the sea floor SF is tilted, in particular.

Further, in the present embodiment, the air storage container rotation wires 151 are respectively coupled with both end portions in the longitudinal direction of the peripheral wall 108 of the air storage container 101 via weights 152 with pulleys directly below and weights 153 with pulleys on the way, which are installed on the sea floor SF. The air storage container rotation wires 151 are each coupled with the wave detection float 141 including a pair of a sea surface wave detection float 142 and an underwater wave detection float 143, which respectively react and float up significantly on the sea surface and in the sea at the same time when the waves reach.

The pair of sea surface wave detection float 142 and the underwater wave detection float 143 each have a streamlined shape in cross section and a disc shape, which minimizes the effects of strong winds and swells on the ocean, and which reliably reacts with the rise of seawater due to waves and tsunamis to be pushed up significantly.

When the waves reach the wave detection float 141, the pair of the sea surface wave detection float 142 and the underwater wave detection float 143 respectively arranged on the sea surface and in the sea are significantly floated up at the same time. The air storage container rotation wire 151 is pulled, the opening 103 of the air storage container 101 rotates upward, and the polluted air PA stored inside is discharged simultaneously.

Further, in the present embodiment, the air storage container 101 is held with the opening 103 facing the sea floor SF direction by the rotation control floats 131, which are connected by totally two horizontality keeping wires 132 respectively attached to wire attachment parts 135 provided at both ends in the longitudinal direction of the peripheral wall 108 corresponding to the top of the air storage container 101. This is a mechanism that the opening 103 of the air storage container 101, which necessitates keeping of the horizontality in order to hold the polluted air PA, which has been laid down, is capable of maintaining stability at normal times.

Further, after the polluted air PA, which has been stored inside in response to the waves, is discharged from the inside of the air storage container 101, the rotation control float 131 causes the opening 103 of the air storage container 101 to return to the posture at normal times facing the sea floor SF direction. Hence, the polluted air PA can be sent from the air supply pipe 121 into the air storage container 101 again.

Further, even when there is no wave and the wave detection float 141 does not operate, in a case where the amount of the polluted air PA supplied to the air storage container 101 via the air supply pipe 121 exceeds a predetermined capacity, the polluted air PA is discharged into the sea from the peripheral edge of the opening 103.

The horizontality keeping wire 132 coupled with the rotation control float 131 does not give an adverse effect that disturbs an effective operation of the air storage container rotation wire 151 by the wave detection float 141 floating up when the waves arrive.

Regarding the attachment position of the air storage container rotation wire 151, either the wire attachment parts 135 corresponding to both ends of the top of the peripheral wall 108 of the air storage container 101 or a wire attachment part 145 on the opposite side of the wave detection float 141 on the peripheral wall 108 of the air storage container 101 can be selected for attachment. For example, in a case where it is desired to adjust the rotation angle at which the opening 103 is rotated according to the geographical feature or water depth on which the air storage container 101 is installed, the adjustment can be easily conducted.

Reference numeral 122 denotes a passage formed in the weight body 112 of the weight 111 in order to be inserted by the air supply pipe 121. The polluted air PA, which has been ejected from an outlet 123 of the passage 122, is stored in the air storage container 101 through the opening 103.

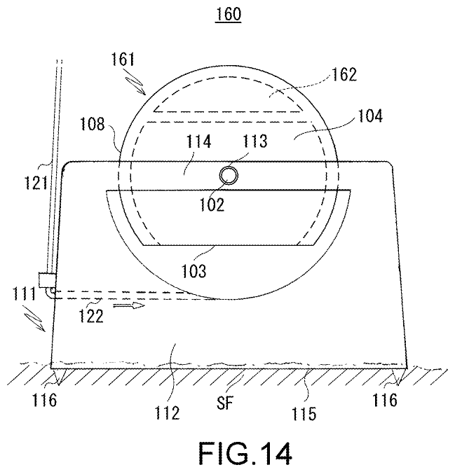

FIG. 14 is a diagram showing a discharging part 160, in which an air storage container 161 configured to be a double structure by providing a buoyancy chamber 162 on an inner upper surface is attached to the weight 111 shown in FIGS. 11 to 13. The same components as those of the discharging part 130 are designated by the same reference numerals.

According to such a discharging part 160, in the air storage container 161 installed in the sea, the buoyancy of the buoyancy chamber 162 automatically causes the opening 103 to face the sea floor SF side. This eliminates the need for using various floats.

Then, when the inside of the air storage container 161 exceeds a predetermined pressure by the polluted air PA supplied to the air storage container 161 via the air supply pipe 121, the polluted air PA is discharged from the peripheral edge of the opening 103 into the sea.

Further, the opening 103 of the air storage container 161 can be rotated upward by a given urging means or the like, so that the polluted air PA stored inside can also be discharged simultaneously. After the discharge, the air storage container 161 automatically returns to the posture in which the buoyancy of the buoyancy chamber 162 causes the opening 103 to face the sea floor SF side.

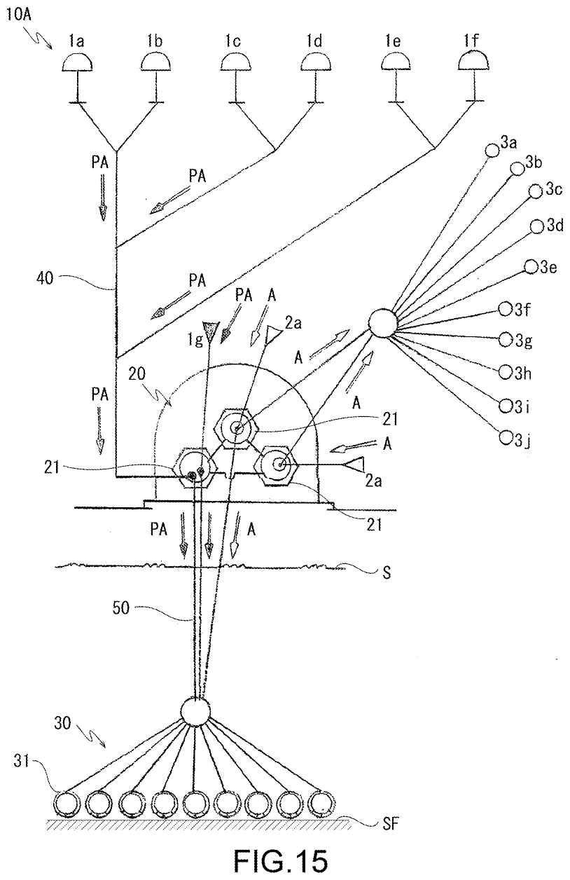

FIG. 15 is a diagram showing another embodiment of the present invention, and differs from the embodiment shown in FIG. 1 in that both the polluted air PA and normal air A can be used.

To be specific, reference numeral 2a denotes an introduction route of the normal air A. For example, the air collecting part 10A similar to that in the embodiment shown in FIG. 1 is installed in a normal air atmosphere such as an area or a park with a small amount of automobile traffic. The air collecting part 10A recovers the normal air A, and introduces the normal air A to the main control part 20.

Then, the normal air A is transported by the pump 21 of the main control part 20 to the discharging part 30 in the same manner as the flow of the polluted air PA by the delivery-side air sending pipe 50.

By making both the polluted air PA and the normal air A available in this manner, the concentration of the polluted air PA is reduced. This is not only more desirable for the marine environment but also ensures the amount of the air supplied to the air storage pipe 31. Therefore, it becomes easier to operate the simultaneous discharging means when a tsunami or the like occurs.

Further, at the normal times, the normal air A recovered from the air collecting part 10A arranged in the normal air atmosphere may be supplied to each area or facility that needs the normal air A. For example, as indicated by reference numerals 3a to 3j in FIG. 15, there are a public facility 3a, a school children facility 3b, a park playground 3c, a stadium 3d, an urban street 3e, an exhibition hall 3f, a hospital medical facility 3g, a public hall 3h, a ball park 3i, a temporary supply base 3j, and the like.

As described heretofore, according to the present invention, by recovering the polluted air such as exhaust gas emitted from automobiles and industrial plants on the spot, air pollution in the area is reduced. In addition, by transporting the recovered polluted air and discharging a certain amount from an air storage container installed in the sea, air pollution can be prevented by the synergistic effect of detoxifying the polluted air with seawater, microorganisms in the sea, and the like.

Furthermore, in a case where the air storage container includes a simultaneous discharging means, the gas inside the air storage container is simultaneously discharged to generate bubbles when a tsunami or an emergency occurs. This mitigates the mass transport energy of the tsunami passing above the air storage container, mitigates the damage, and prevents the invasion of ships.

1. A device for recovering polluted air, the device comprising:
an air collecting part; a main control part; a discharging part; and an air sending pipe;
the air collecting part including a cover body, a lower side of which is opened, and a filter member attached to an inside of the cover body,
the main control part including a pump capable of sucking and delivering gas,
the discharging part including an air storage container to be installed in the sea,
wherein the air sending pipe couples between the air collecting part and the main control part and between the main control part and the discharging part to permit movement of the gas between the parts, and
wherein the gas that is polluted air is sucked from the air collecting part by the pump and is delivered to the discharging part, and the gas is discharged from the air storage container into the sea.

2. The device for recovering polluted air according to claim 1, wherein
the air storage container has a hollow cylindrical shape with both ends closed, and includes a plurality of ejection ports each including a pressure adjustment cap, and
after an inside of the air storage container is filled with the gas, by discharging a given amount of the gas from the ejection port through the pressure adjustment cap, while the inside of the air storage container is kept at a predetermined pressure, the gas is dischargeable.

3. The device for recovering polluted air according to claim 2, wherein
the pressure adjustment cap includes: a cap body that has a bottomed hollow shape in which an opening top part is connected to surround the ejection port, and a through hole formed in a peripheral wall; a valve seat arranged in the cap body; and a float valve arranged in the cap body, seated on the valve seat by buoyancy, and capable of closing the ejection port, and
in a case where the inside of the air storage container exceeds the predetermined pressure due to the gas that has been delivered, the float valve is separated from the valve seat, the given amount of the gas is discharged from the ejection port that is opened through the through hole of the cap body, and the inside of the air storage container is kept at the predetermined pressure at normal times.

4. The device for recovering polluted air according to claim 1, wherein the air storage container has a semi-cylindrical shape with a lower surface opening and both ends closed, and after the inside of the air storage container is filled with the gas, by discharging the gas that is excessive from a peripheral edge of the opening, while the gas in the air storage container is kept at a given amount, the gas is dischargeable.

5. The device for recovering polluted air according to claim 1, wherein the air storage container has a hollow cylindrical shape with both ends closed, and includes a plurality of ejection ports each including a check valve, and an inside of the air storage container includes an air supply pipe that communicates with the air sending pipe, after the inside of the air storage container is filled with the gas supplied through the air supply pipe, by discharging a given amount of the gas from the ejection port, while the inside of the air storage container is kept at a predetermined pressure, the gas is dischargeable.

6. The device for recovering polluted air according to claim 1, wherein the air storage container has a semi-cylindrical shape with a lower surface opening and both ends closed, a wire connected with a float is attached to a peripheral wall of the air storage container, and the float reacts with a wave and pulls the wire, the air storage container rotates, and the gas stored in the air storage container is dischargeable.

7. The device for recovering polluted air according to claim 1, wherein:
a discharge hole is formed to penetrate through a lower surface of the air sending pipe and a trap that covers the discharge hole is provided, on a route of the air sending pipe,
the trap includes a trap member that covers the discharge hole formed on the air sending pipe, a drain hole that is formed to penetrate through the lower surface of the trap member, and a drain screw to be screwed into the drain hole, and
water or minute foreign matters contained in the gas passing through the air sending pipe are dropped into the trap member and are dischargeable from the drain hole.

8. The device for recovering polluted air according to claim 1, wherein the air storage container includes a simultaneous discharging device capable of simultaneously discharging the gas stored in an inside.

9. The device for recovering polluted air according to claim 2, wherein
a discharge hole is formed to penetrate through a lower surface of the air sending pipe and a trap that covers the discharge hole is provided, on a route of the air sending pipe,
the trap includes a trap member that covers the discharge hole formed on the air sending pipe, a drain hole that is formed to penetrate through the lower surface of the trap member, and a drain screw to be screwed into the drain hole, and
water or minute foreign matters contained in the gas passing through the air sending pipe are dropped into the trap member and are dischargeable from the drain hole.

10. The device for recovering polluted air according to claim 3, wherein
a discharge hole is formed to penetrate through a lower surface of the air sending pipe and a trap that covers the discharge hole is provided, on a route of the air sending pipe,
the trap includes a trap member that covers the discharge hole formed on the air sending pipe, a drain hole that is formed to penetrate through the lower surface of the trap member, and a drain screw to be screwed into the drain hole, and
water or minute foreign matters contained in the gas passing through the air sending pipe are dropped into the trap member and are dischargeable from the drain hole.

11. The device for recovering polluted air according to claim 4, wherein
a discharge hole is formed to penetrate through a lower surface of the air sending pipe and a trap that covers the discharge hole is provided, on a route of the air sending pipe,
the trap includes a trap member that covers the discharge hole formed on the air sending pipe, a drain hole that is formed to penetrate through the lower surface of the trap member, and a drain screw to be screwed into the drain hole, and
water or minute foreign matters contained in the gas passing through the air sending pipe are dropped into the trap member and are dischargeable from the drain hole.

12. The device for recovering polluted air according to claim 5, wherein
a discharge hole is formed to penetrate through a lower surface of the air sending pipe and a trap that covers the discharge hole is provided, on a route of the air sending pipe,
the trap includes a trap member that covers the discharge hole formed on the air sending pipe, a drain hole that is formed to penetrate through the lower surface of the trap member, and a drain screw to be screwed into the drain hole, and
water or minute foreign matters contained in the gas passing through the air sending pipe are dropped into the trap member and are dischargeable from the drain hole.

13. The device for recovering polluted air according to claim 6, wherein
a discharge hole is formed to penetrate through a lower surface of the air sending pipe and a trap that covers the discharge hole is provided, on a route of the air sending pipe,
the trap includes a trap member that covers the discharge hole formed on the air sending pipe, a drain hole that is formed to penetrate through the lower surface of the trap member, and a drain screw to be screwed into the drain hole, and
water or minute foreign matters contained in the gas passing through the air sending pipe are dropped into the trap member and are dischargeable from the drain hole.

14. The device for recovering polluted air according to claim 2, wherein the air storage container includes a simultaneous discharging means capable of simultaneously discharging the gas stored in an inside.

15. The device for recovering polluted air according to claim 3, wherein the air storage container includes a simultaneous discharging means capable of simultaneously discharging the gas stored in an inside.

16. The device for recovering polluted air according to claim 4, wherein the air storage container includes a simultaneous discharging means capable of simultaneously discharging the gas stored in an inside.

17. The device for recovering polluted air according to claim 5, wherein the air storage container includes a simultaneous discharging means capable of simultaneously discharging the gas stored in an inside.

18. The device for recovering polluted air according to claim 6, wherein the air storage container includes a simultaneous discharging means capable of simultaneously discharging the gas stored in an inside.

19. The device for recovering polluted air according to claim 7, wherein the air storage container includes a simultaneous discharging means capable of simultaneously discharging the gas stored in an inside.

20. A device for recovering polluted air, the device comprising:
an air collecting part including a cover body, a lower side of which is opened, and a filter member attached to an inside of the cover body;
a main control part including a pump capable of sucking and delivering gas;
a discharging part including an air storage container to be installed in the sea;
an air sending pipe that couples between the air collecting part and the main control part and between the main control part and the discharging part to permit movement of the gas between the parts;
wherein the gas that is polluted air is sucked from the air collecting part by the pump and is delivered to the discharging part, and the gas is discharged from the air storage container into the sea; and
wherein the air storage container has a hollow cylindrical shape with both ends closed.
